(19) United States
(12) Patent Application Publication
(10) Pub. No.: US 2023/0253580 A1
(43) Pub. Date: Aug. 10, 2023

(54) SINUSOIDAL VERTICAL GASKET CONTOUR FOR BIPOLAR PLATES

(71) Applicant: Dana Automotive Systems Group, LLC, Maumee, OH (US)

(72) Inventors: Michael J.R. BARDELEBEN, Oakville (CA); Nick KALMAN, Oakville (CA); Christopher M. COOK, McKenzie, TN (US); Eve STEIGERWALT, Maumee, OH (US); Dakota FOSTER, Paris, TN (US)

(21) Appl. No.: 18/160,239

(22) Filed: Jan. 26, 2023

Related U.S. Application Data
(60) Provisional application No. 63/267,834, filed on Feb. 10, 2022.

(51) Int. Cl. H01M 8/0276; H01M 8/0206; H01M 8/0247; F16J 15/06

(52) U.S. Cl. CPC H01M 8/0276; H01M 8/0206; H01M 8/0247; F16J 15/06

(57) ABSTRACT

A system may comprise a first plate arranged directly against a second plate and defining a gasket groove, the plates each parallel to one another and to a plane; and a gasket formed in a plane and having a sinusoidal variation in a direction normal to the plane. The first and second plate may form a bipolar plate and may be used as a component of a fuel cell. The section of the gasket with sinusoidal variation may be fit to the groove. The gasket may have a bead that may fit to a fitting, such as a gasket, on another plate or surface to seal the contents of a fuel cell.

### CROSS REFERENCE TO RELATED APPLICATION

The present application claims priority to U.S. Provisional Application No. 63/267,834, entitled “SINUSOIDAL VERTICAL GASKET CONTOUR FOR BIPOLAR PLATES”, and filed on Feb. 10, 2022. The entire contents of the above-listed application are hereby incorporated by reference for all purposes.

### TECHNICAL FIELD

The present description relates generally to components, systems, and methods for bipolar plates, such as for a fuel cell.

### BACKGROUND AND SUMMARY

Gaskets may be used a variety of systems, such as energy storage or generation devices. Gaskets may use mechanical support from mating surfaces in order to apply sealing pressure to a sealing element, such as an elastomer. Further, gaskets may be positioned around a perimeter and so in some examples a continuous supporting structure may be used underneath the sealing element.

Such approaches, however, may reduce access to an interior of an assembly if the gasket is on the exterior surface. While an approach to provide a gasket in a fuel cell application includes overmolding a gasket onto an air-cooled or liquid-cooled metallic bipolar plate assembly, disadvantages persist. Air-cooling utilizes openings around the entire perimeter to allow access in between the anode and cathode plates with a reduced pressure drop. Likewise, liquid-cooling utilizes openings around the entire perimeter to allow access in between the anode and cathode plates with a reduced pressure drop. When the gasket is placed on the exterior sides of the plate, it therefore could not be a continuously flat surface (e.g., in the x-y plane) as this may close off the embedded cooling channels in between the plates.

The inventors herein have recognized the above issues and possible approaches to address them. Therefore, in an example, a gasket formed in an x-y plane has a sinusoidal bridge or arch shape where a thickness in a z-direction varies around a centerline.

Further, in an example, a system may comprise a first plate arranged directly against a second plate and defining a gasket groove, the plates each parallel to one another and to a plane; and a gasket formed in a plane and having a sinusoidal variation in a direction normal to the plane

In this way, it is possible to still allow support of the sealing structure on the top and bottom of the plates while also allowing access for the cooling medium. Further, such an approach allows access to the interior of the assembly while still providing mechanical sealing force to the elastomer on the exterior faces. Simultaneously, a substrate (e.g., a metal or composite plate) may be used that is formable, and thus may be used with a smooth bridge design.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a simplified diagram of a segment of a hydrogen fuel cell using bipolar plates.

FIG. 2 shows a side view down the x axis of a model of an upper and lower plate of a bipolar sinusoidal plate that may be used as the bipolar plate in FIG. 1.

FIG. 3 Shows a portion and cutout of a gasket fitted to the upper or lower plate that form bipolar plate with a sinusoidal bridge with cooling apertures in FIG. 2.

FIG. 4 shows a view of the gasket from FIG. 3 fitted into one half of the bipolar sinusoidal plate in FIG. 2 from upper perspective.

### DETAILED DESCRIPTION

A gasket, system, and method are described herein. In an example, a gasket or groove may sinusoidally vary in a z-dimension, for example along a direction perpendicular to a perimeter. The gasket may be fit to a groove. The gasket and groove may enclose the center of a plate and be enclosed by the perimeter of a plate. The groove may be incorporated into a structure that is formed from and extends from a plate. The structure may be hollow allowing the gasket to be surrounded by the inner surfaces of the structure. The gasket or a segment of the gasket may therein have bridge-shaped curves and bridge-shaped openings offset from the arches and apertures, respectively, of a bridge. The structure may be joined to a structure of another plate at a plurality of appendages. When joined at appendages, the structures may form a bridge between the two plates.

The groove formed from the structure may sinusoidally vary in thickness, wherein the thickness be a distance of material vertically relative to the lengths of a structure. For example, the thickness of the groove may be normal to a plane the plates are parallel with and vary in distance in a sinusoidal repeating pattern. The sinusoidal variation in thickness forms arches between the appendages of the structures.

Likewise, the gasket or a segment of the gasket varies sinusoidally in thickness, wherein the thickness may be a distance of material vertically relative to the lengths of a gasket. For example, the thickness of the gasket may be normal to a plane the plates are parallel with and vary in distance in a sinusoidal repeating pattern. The gasket may vary in thickness along a sealing center line in the z-direction. In some areas the gasket may be thinner (e.g., on top of a bridge) and in some areas it may be thicker (at ends of the bridges where the two plates come into contact).

In an example, the curved shape allows improved formation of the metal plate. For example, the sinusoidal shape of the curved arches of the bridge may allow formation of the metal plate via stamping. For example, this approach allows for more uniform sealing pressure in the gasket transitions across multiple bridges (which may correspond to openings underneath which access the interior of the assembly). In addition, this bridge design will allow for greater compressive strength of the underlying metal, thus enabling greater sealing pressure to be applied.

The gasket or gaskets supported by a bridge, may be formed via overmolding the gasket. Through-holes may be optionally added for each bridge that may fluidically couple each of the bridges when not fitted to a beaded gasket. The through holes allow over-molding of beaded gaskets to both sides of a bipolar plate assembly in one operation.

In this way, rather than a gasket groove floor being flat within the x-y plane, a groove is provided with a curved (and in an example sinusoidal) vertical variation (in the z-direction) to allow for bridges overflows underneath the plate to be sealed. The seal may maintain a constant bead height in relation to the flange and has a varying groove depth to accommodate the openings underneath accessing the interior of the assembly. The curved (and in an example sinusoidal) shape allows greater compressive force to be applied to the gasket to seal greater pressures. Through-holes may be optionally added to allow over-molding of both sides of the plate in one operation.

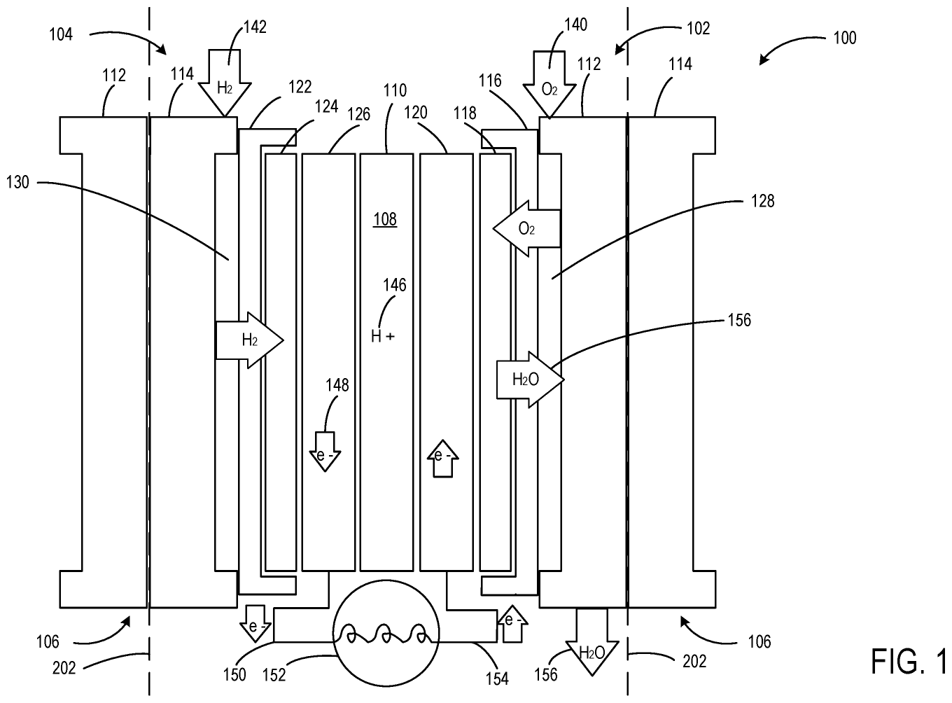

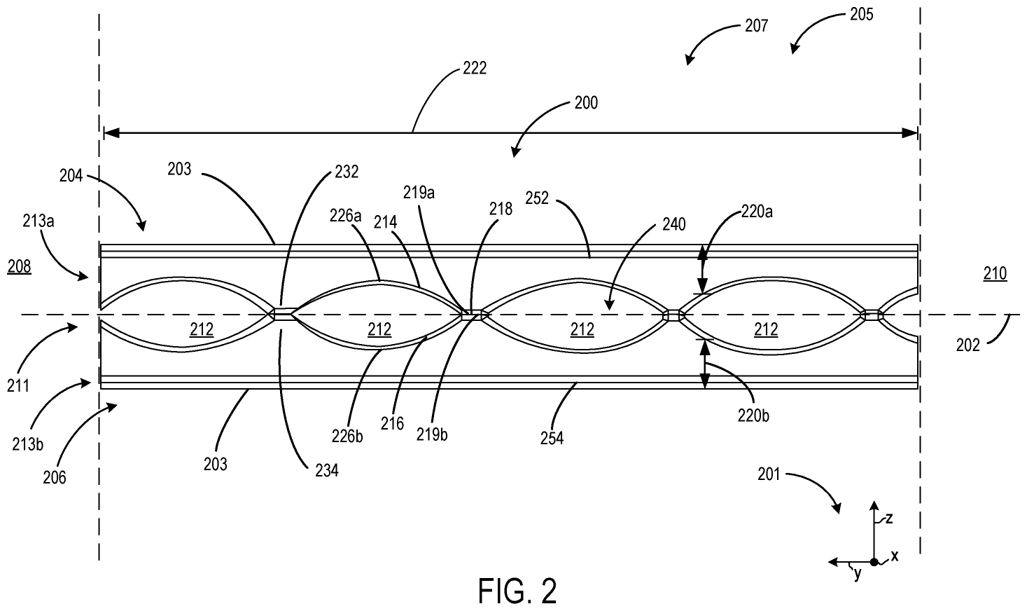

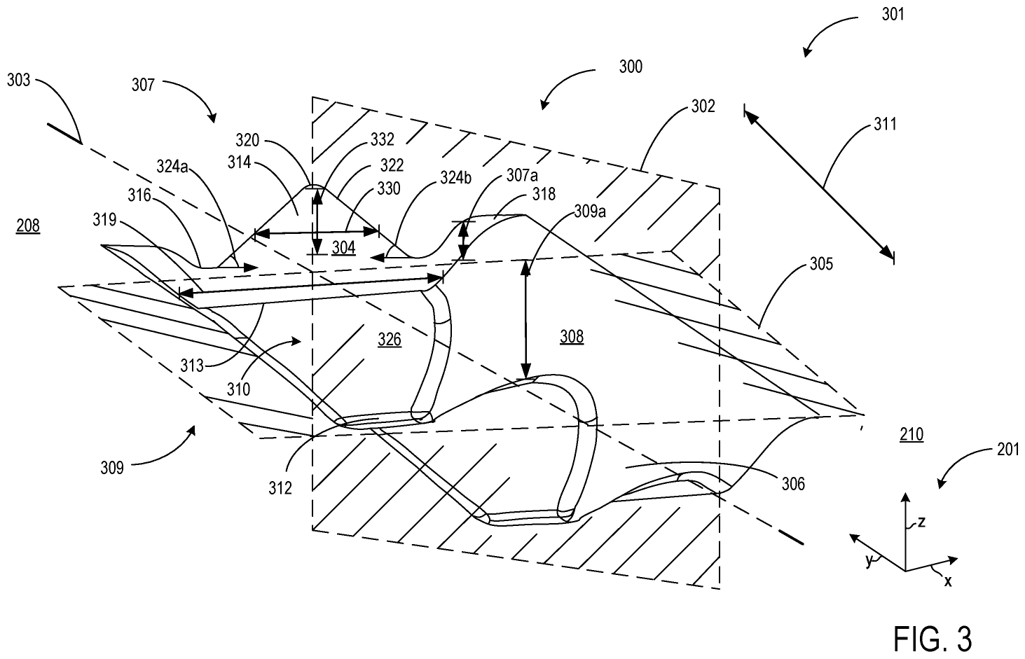

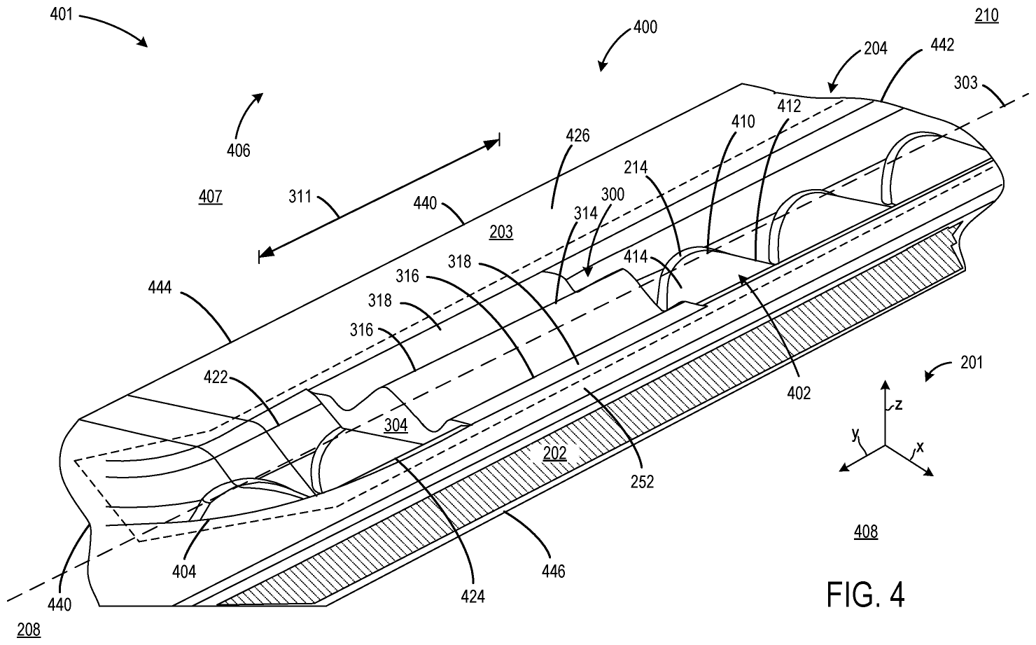

FIG. 1 illustrates a simplified schematic of a segment of a hydrogen fuel cell that uses bipolar plates. FIG. 2 shows side view of along the x-axis of an upper and lower plate that form the bipolar plate with a sinusoidal bridge of cooling ports. The cooling ports may be referred to herein as sinusoidal cooling apertures (e.g., 212 in FIG. 2) as described herein. FIG. 3 shows an isometric view and cutout of a section of a gasket that may be used to space separate the interior components of the fuel cell from and fitted to the bipolar plate. FIG. 4 shows the section of the gasket from FIG. 3 inserted and fitted to a section of one half of the bipolar plate from FIG. 2.

The following description relates to a gasket used in a bipolar plate. The bipolar plate may form a sinusoidal bridge of cooling ports for a gasket to be fitted to. The bipolar plate may be used in a hydrogen or other fuel cells. However, the bipolar plate may be used in other applications that have been considered. In a fuel cell there may be a plurality of gaskets and bipolar plates. The bipolar plates may have an upper half and a lower half. One half of a bipolar plate may be an anode and another half of the bipolar plate may be a cathode. The cathode and anode plates help to contain and promote the transfer of hydrogen fuel and oxygen through the fuel cell. The cathode and anode plates help to transmit an electrical current to an adjacent cell that promotes the reaction within a hydrogen fuel cell and power components in an electrical circuit.

The example fuel cell in FIG. 1 illustrates the uses of a bipolar plate and gasket. Additionally, the example fuel cell in FIG. 1 illustrates the operation within a fuel cell and how they are affected by the anode and cathode sides of a bipolar plate.

FIG. 1 illustrates a simplified embodiment of a segment of a hydrogen fuel cell 100. The fuel cell may have a cathode side 102 and an anode side 104. Enclosing the hydrogen fuel cell 100 may be a plurality of bipolar plates 106. In the center of the hydrogen fuel cell 100 may be an electrolyte 108 suspended in a proton exchange membrane 110.

The plurality of bipolar plates 106 may be formed from two halves. The first half of a bipolar plate 106 may be a cathode plate 112. The second half of a bipolar plate may be an anode plate 114. A bipolar plate 106 may be split into a cathode plate 112 and an anode plate 114 by a centerline plane 202 that will be discussed herein in FIG. 2. Both the cathode plate 112 and anode plates 114 that compose the bipolar plates 106 may be metallic and are conductive. For other embodiments both the cathode plates 112 and anode plates 114 that compose the bipolar plates 106 may be made from a composite. The centerline may be substantially parallel with the x axis (e.g., parallel with the x axis or to the centerline plane 202 within +/−5%). The z axis may be normal to the surface of the bipolar plate (e.g., the z axis may be perpendicular to within +/−5% of a line parallel to the surface of the bipolar plate or to the centerline plane 202).

The cathode plate 112 on the cathode side 102 may act as a part of and/or enclose a negatively charged electrode for the fuel cell 100. The cathode plate 112 may be part of the cathode side 102 of the fuel cell 100. The anode plate 114 on the anode side 104 may act as a part of and/or enclose a positively charged electrode for the fuel cell 100. The anode plate 114 may be part of the anode side 104 of the fuel cell 100.

The cathode plate 112 on the cathode side 102 of the hydrogen fuel cell 100, may be coupled to an anode plate 114. The anode plate 114 on cathode side 102 of the hydrogen fuel cell 100, may enclose and be a part of another anode side of an additional hydrogen fuel cell layer not shown in FIG. 1. The anode plate 114 on the anode side 104 of the hydrogen fuel cell 100, may be coupled to a cathode plate 112. The cathode plate 112 on anode side 104 of the hydrogen fuel cell 100, may enclose and be a part of another cathode side of an additional hydrogen fuel cell layer not shown in FIG. 1.

The cathode plate 112 may enclose a cathode gasket 116. The cathode gasket partially separates the cathode diffusion membrane 118 and the cathode catalyst 120 from the cathode plate. The cathode gasket 116 encircles and creates a seal between the edges of the cathode diffusion membrane 118 and the exterior of the fuel cell 100.

The anode plate 114 may enclose an anode gasket 122. The anode gasket 122 forms a barrier between the anode diffusion membrane 124 and the anode catalyst 126 from the anode plate 114. The anode gasket 122 encircles and creates a seal between the edges of the anode diffusion membrane 124 and the exterior of the fuel cell 100.

The seal created by the cathode gasket 116 prevents oxygen 140 from leaking or diffusing out of the fuel cell 100. The oxygen 140 shown in FIG. 1 may be delivered into the fuel cell as a component of air. The oxygen 140 may also be delivered into the fuel cell in a form that is of greater purity (e.g., higher percent content of oxygen) than air. The oxygen 140 shown in FIG. 1 is flushed into a first space 128 between the cathode plate 112 and cathode diffusion membrane 118. Other elements in air or impurities may be separated from oxygen 140 by the diffusion membrane. The cathode diffusion membrane 118 may contain pores or apertures small enough to favor oxygen 140 over other elements or impurities in air. The diffusion membrane may be charged or be chemically favorable to attract oxygen more so than other elements or impurities in the air.

The cathode side 102 and cathode diffusion membrane 118 of the hydrogen fuel cell 100 may deliver and purify oxygen 140 into the cathode catalyst 120 and center of the fuel cell 100. The cathode catalyst 120 may promote the oxygen 140 to react with the hydrogen protons 146 in the electrolytes 108 and the proton exchange membrane 110.

The seal created by the anode gasket 122 prevents hydrogen fuel 142 from leaking or diffusing out of the fuel cell 100. The hydrogen fuel 142 shown in FIG. 1 may be delivered in a relatively pure (e.g., mostly hydrogen such as above 99% hydrogen per mole) form into the hydrogen fuel cell 100. The hydrogen fuel 142 shown in FIG. 1 may be delivered into the hydrogen fuel cell 100 in a gaseous state. The hydrogen fuel 142 shown in FIG. 1 may be flushed into a second space 130 between the anode plate 114 and anode diffusion membrane 124. Impurities may be separated from hydrogen fuel 142 as hydrogen molecule diffuse through the anode diffusion membrane 124. Impurities in this example may be unwanted molecules, elements, or ions that may cause degradation to components of or interfere with the chemical reactions inside the fuel cell 100. The anode diffusion membrane 124 may contain pores or apertures small enough to favor hydrogen fuel 142 over other elements, molecules, or impurities. The diffusion membrane may be charged or be chemically favorable to attract hydrogen fuel 142 more so than other elements, molecules, or impurities.

The anode side 104 and anode diffusion membrane 124 of the hydrogen fuel cell 100 may deliver and purify hydrogen fuel 142 into the anode catalyst 126 and center of the fuel cell 100. The anode catalyst 126 may promote the hydrogen molecules in the hydrogen fuel 142 react and separate into hydrogen ions with a positive charge. The positively charged hydrogen ions may be referred to as hydrogen protons 146. The reaction of hydrogen fuel 142 into hydrogen protons 146 generates electrons 148.

The reaction of a hydrogen molecule in the presence of the anode catalyst 126 may generate two hydrogen protons 146 and two electrons 148. The reaction of two hydrogen molecules in the presences of the anode catalyst 126 may generate four hydrogen protons 146 and four electrons 148.

The electrons 148 formed from the hydrogen fuel 142 reacting into hydrogen protons 146 may leave the anode catalyst 126 through electrical wiring 150 in the form of electricity. The electrons 148 may be delivered through electrical wiring 150 into an electrical circuit 152 to power various consumers. For one example, a consumer in the electrical circuit 152 may include an electric motor or generator of a vehicle or building the hydrogen fuel cell 100 is housed in. For another example, a consumer in the electrical circuit 152 may include a light in a vehicle or in a building. The electrical circuit 152 may be grounded to the cathode catalyst 120 through grounding electrical wiring 154. The grounding electrical wiring 154 may be connected to and deliver electrons 148 to the cathode catalyst 120 to promote reactions between the hydrogen protons 146 and oxygen 140.

For one example, in one embodiment water 156 may leave the hydrogen fuel cell 100 through the cathode diffusion membrane 118 as a byproduct. For one example, in one embodiment of fuel cell 100, water may collect in first space 128. Water 156 may leave the first space 128 and hydrogen fuel cell 100 through a single or plurality of ports in one of the bipolar plates 106. For the example shown in FIG. 1, water 156 may leave through the bipolar plate 106 on the cathode side 102. There may be other examples embodiments where water leaves the fuel cell through different components, and such embodiments have been contemplated.

A set of reference axes 201 are provided for comparison between views shown in FIG. 2-4. The reference axes 201 indicate a y-axis, an x-axis, and a z-axis. In one example, the z-axis may be parallel with a direction of gravity and the x-y plane may be parallel with a horizontal plane that a bipolar sinusoidal plate assembly 200 may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

FIG. 2 shows a section of bipolar sinusoidal plate assembly 200 that may be the bipolar plate 106 shown in FIG. 1. FIG. 2 shows the bipolar sinusoidal plate assembly 200 is from a view 205. View 205 is a side perspective where the viewer is looking down the x axis. FIG. 2 shows a section of the bipolar sinusoidal plate assembly.

FIG. 2 shows the bipolar sinusoidal plate assembly 200 may be divided into two halves by a centerline plane 202. The centerline plane 202 aligns with the x and y axis (e.g., the x and y axis are substantially parallel with and/or may be a part of the plane). The bipolar sinusoidal plate assembly 200 may have two exposed surfaces. The exposed surfaces may be referred to herein as gasket supporting surfaces 203. The gasket supporting surfaces 203 bipolar sinusoidal plate assembly may be vertically aligned (e.g., the z axis may be normal to the exposed surfaces).

FIG. 2 shows the centerline plane 202 may divide the bipolar sinusoidal plate assembly 200 into a first plate and a second plate. For the example in view 205 the first plate is an upper plate 204 and the second plate is a lower plate 206. The upper plate 204 and lower plate 206 may be arranged to couple along the centerline plane 202. The upper plate 204 and lower plate 206 may be coupled via joining. The upper plate 204 and lower plate 206 may be a first polar plate a second polar plate, respectively, wherein the first or second bipolar plate may be either an anode plate or a cathode plate. For one example, in one embodiment the upper plate 204 may be an anode plate 114 from FIG. 1 while the lower plate 206 may be a cathode plate 112 from FIG. 1. For another example, in one embodiment the upper plate 204 may be a cathode plate 112 from FIG. 1 while the lower plate 206 may be an anode plate 114 from FIG. 1.

FIG. 2 and the bipolar sinusoidal plate assembly 200 may have a left side 208 and a right side 210, acting as a first side and second side, respectively. FIG. 2 shows that sinusoidal cooling apertures 212 may form between the upper plate 204 and lower plate 206. The sinusoidal cooling apertures 212 may be located on and divided by the centerline plane 202.

FIG. 2 shows the upper plate 204 and lower plate 206 contain structures referred to herein as sinusoidal bridges 211. The sinusoidal bridges 211 may resemble an arch bridge or an aqueduct due to a plurality of upper sinusoidal arches 214 and lower sinusoidal arches 216. The upper sinusoidal arches 214 may be formed on the upper plate 204 and the lower sinusoidal arches 216 may be formed on the lower plate 206. The upper sinusoidal arch 214 and lower sinusoidal arch 216 are curved in shape and follow the path of a sinusoidal function. FIG. 2 shows the upper sinusoidal arch 214 and lower sinusoidal arch 216 vary in the z direction and cut sinusoidal shaped gaps in the material of the upper plate 204 and lower plate 206, respectively.

The sinusoidal bridges 211 may be formed from a first structure 213a and a second structure 213b. The first structure 213a may be formed of the upper plate 204 and the second structure 213b may be formed of the lower plate 206. The first structure 213a and second structure 213b may each referred to as be bridges. The first structure 213a and second structure 213b may each have a first thickness 220a and a second thickness 220b, respectively. The first and second thicknesses 220a, 220b may be approximately normal to the plane 202 and may be of a distance that varies. The first and second thicknesses 220a, 220b may be approximately parallel with the z-axis and may vary in distance with respect to the z-axis. The first and second thicknesses 220a, 220b may vary in distance sinusoidally in a repeating pattern. The sinusoidal cooling apertures 212 may be a plurality of openings formed between the first and second structures 213a, 213b of the sinusoidal bridges 211.

The portions of the first structure 213a and second structure 213b in segment 207 may be of a length 222. For the example in view 205, the length 222 may be parallel with the y-axis. The first and second thicknesses 220a, 220b may vary in distance, with respect to the z-axis, at different positions axially, with respect to an axis parallel with the length 222. The first and second thicknesses 220a, 220b may vary, with respect to the z-axis, at different points along the y-axis or an axis parallel to the y-axis.

There may be a plurality of openings to the sinusoidal bridges 211, that may be referred to herein as bridge openings. The first structure 213a and second structure 213b may each form an opening on the surfaces 203 of the upper and lower plates 204, 206, respectively. The first and second structures 213a, 213b may be hollow. The openings and hollow portions of the first and second structures 213a, 213b may define and act as grooves. The grooves of the first and second structures 213a, 213b may support and be fitted to a gasket, such as a beaded gasket.

The entirety of the first structure 213a and the second structure 213b may be located and form a continuous perimeter about the centers of the upper plate 204 and lower plate 206, respectively. For these aforementioned segments, the first thickness 220a may vary sinusoidally, with respect to the z-axis, at different positions along the lengths of the first structure 213a. For these aforementioned segments, the second thickness 220b may vary sinusoidally, with respect to the z-axis, at different positions along the lengths of the second structure 213b.

When the upper plate 204 and lower plate 206 are coupled together, the upper sinusoidal arches 214 and lower sinusoidal arches 216 may meet and terminate at sinusoidal bridge contact points 218. The upper sinusoidal arches 214 make the first structure 213a of sinusoidal bridges 211 on the upper plate 204 to vary in material in the z direction. The lower sinusoidal arches 216 make the second structure 213b of the sinusoidal bridges 211 on the lower plate 206 to vary in material in the z direction. The sinusoidal shape of the upper sinusoidal arches 214 and lower sinusoidal arches 216 allow for sinusoidal bridges 211 as well as the upper plate 204 and lower plate 206 to be manufactured through stamping or pressing. An example design of upper plate 204 and lower plate 206 may be manufactured through stamping with reduced chances of degradation during manufacturing. The shape and structure of the upper sinusoidal arches 214, lower sinusoidal arches 216, and sinusoidal bridges 211 allow for the upper plate 204 and lower plate 206 to be manufactured through stamping without sacrificing the sealing capability.

There are a plurality of first surfaces 219a on the upper plate 204 and second surfaces 219b on the lower plate 206. The first surfaces 219a and second surfaces 219b may be in surface sharing contact at the plane 202 and the contact points 218. Each of the upper sinusoidal arches 214 may terminate at and form into two of the first surfaces 219a. Each of the lower sinusoidal arches 216 may terminate at and form into two of the second surfaces 219b. The first structure 213a may have a plurality of first spandrels 232 located between the upper sinusoidal arches 214. The second structure 213b may have a plurality of second spandrels 234 located between the lower sinusoidal arches 216. The first and second spandrels 232, 234 may act as appendages of the upper and lower plates 204, 206, respectively. The first surfaces 219a may be formed on the first spandrels 232. The second surfaces 219b may be formed on the second spandrels 234.

The first thickness 220a may not vary and may be approximately constant, with respect to the z-axis, when above and normal to the first surfaces 219a. The second thickness 220b may not vary and may be approximately constant, with respect to the z-axis, when below and normal to the second surfaces 219b. The first surfaces 219a may be locations of a local maximum distance for first thickness 220a. The second surfaces 219b may be locations of a local maximum distance for second thickness 220b. Each of the upper sinusoidal arches 214 may have a first peak 226a and each of the lower sinusoidal arches 216 may have a second peak 226b. The first peaks 226a may be locations of local minimum distances for first thickness 220a. The second peaks 226b may be location of local minimum distances for the second thickness 220b. The first peaks 226a and second peaks 226b may be referred to herein as bridge peaks.

The upper sinusoidal arch 214 provides mechanical support to the sinusoidal bridges 211 and the upper plate 204. The lower sinusoidal arch 216 provides mechanical support to the sinusoidal bridges 211 and the lower plate 206. External forces, such as in the z direction, may be distributed across the material of the upper sinusoidal arches 214 and lower sinusoidal arches 216. External forces distributed across the upper sinusoidal arch 214 and lower sinusoidal arch 216, may be directed into the sinusoidal bridge contact points 218. The structure of the sinusoidal bridges 211 and sinusoidal arches 214, 216 reduces the material and weight of the upper plate 204 and the lower plate 206. The structure of the sinusoidal bridges 211 and sinusoidal arches 214, 216 may increase compressive and mechanical strength of the upper plate 204 and lower plate 206. Increase in compressive strength provided by the sinusoidal bridges 211 and sinusoidal arches 214, 216, may allow for greater sealing pressure to be applied to the bipolar sinusoidal plate assembly 200 compared to non-patent example bipolar plates. An increase in compressive strength provided by the sinusoidal bridges 211 and sinusoidal arches 214, 216, may allow for greater sealing pressure to be applied to the beaded gasket compared (e.g., the beaded gasket segment 300 in FIG. 3) to non-patent example beaded gaskets.

The plurality of upper sinusoidal arches 214, lower sinusoidal arches 216, and sinusoidal bridges 211 distribute the compressive strength and sealing pressure across the bipolar sinusoidal plate assembly 200. The upper sinusoidal arches 214, lower sinusoidal arches 216, and other structural features of sinusoidal bridges 211 may evenly distribute and/or make a desired sealing pressure nominally similar across the bipolar sinusoidal plate assembly 200. A more even distribution of pressure may prevent acute or chronic degradation of the structure of the bipolar sinusoidal plate assembly 200 due to uneven forces.

FIG. 2 shows the upper plate 204 and lower plate 206 may be coupled together at a plurality of sinusoidal bridge contact points 218. When the upper plate 204 and a lower plate 206 are coupled together at the sinusoidal bridge contact points 218, the upper sinusoidal arches 214 and lower sinusoidal arches 216 form a plurality of sinusoidal cooling apertures 212 and a convection cavity 240. The cooling apertures 212 may act as bridge openings, fluidically coupled through the sinusoidal bridges 211 to the convection cavity 240. The height of the sinusoidal cooling apertures 212 vary in the z direction. The convection cavity 240 may be located behind sinusoidal bridges 211 and sinusoidal cooling apertures 212 in the x direction. Both the plurality of sinusoidal cooling apertures 212 and the sinusoidal bridges 211 may extend around the perimeter of the bipolar sinusoidal plate assembly 200.

Extensions of material may be formed from the gasket supporting surfaces 203 of the upper plate 204 and lower plate 206. The extension of material from the upper plate 204 may be referred to as an upper plate shoulder 252. The extension of material from the lower plate 206 may be referred to as a lower plate shoulder 254.

FIG. 2 shows the upper plate shoulder 252 above the sinusoidal cooling apertures 212. FIG. 2 shows the upper plate shoulder 252 above the upper sinusoidal arch 214 of the upper plate 204 and sinusoidal bridges 211.

FIG. 2 shows the lower plate shoulder 254 is below the sinusoidal cooling apertures 212. FIG. 2 shows the lower plate shoulder 254 is below the lower sinusoidal arch 216 of the lower plate 206 and the sinusoidal bridges 211.

The upper plate 204, lower plate 206, and bipolar sinusoidal plate assembly 200 may be fluid cooled. The sinusoidal cooling apertures 212 act as channels to remove heat from the upper plate 204 and lower plate 206. Heat may be removed from the upper plate and lower plate of the bipolar sinusoidal plate assembly 200 primarily through convection. A fluid that may be gaseous or liquid may be used as a medium for convection and heat removal. For an example, cooling fluid may include air. For another example, cooling fluid may include liquid coolant.

For one example, an embodiment of the bipolar sinusoidal plate assembly 200 may be gas cooled and use air as cooling fluid. For an embodiment of a sinusoidal plate assembly 200 that may be air cooled, air is used as fluid to remove heat through convection. For one embodiment, air external to the fuel cell and plates may drift through sinusoidal cooling apertures 212. For this embodiment, air external to the fuel cell and plates be driven through and out of sinusoidal cooling apertures 212 due to convection driven by temperature and/or pressure differences. The surfaces of the upper plate 204 and lower plate 206 that form the convection cavity 240 that may be of a high surface area. As the upper plate 204 and lower plate 206 increase in temperature, air within the convection cavity 240 may circulate and remove heat through convection. Air external to the fuel cell and plate may also be driven through the sinusoidal cooling apertures 212 via the use of implement, such as a blower or fan, to increase convection and removal of heat from the bipolar sinusoidal plate assembly 200. The upper plate shoulder 252 and lower plate shoulder 254 may also help to direct air into the sinusoidal cooling apertures 212 instead of against the bipolar sinusoidal plate assembly 200

For another example, an embodiment of the bipolar sinusoidal plate assembly 200 may be liquid cooled. For an embodiment of a sinusoidal plate assembly 200 that may be liquid cooled, a liquid cooling fluid, such as cooling water, may be used to remove heat through convection. For one embodiment, liquid external to the fuel cell and plates may be driven through the cooling apertures 212 by the force. This force may be a slight pressure differential above a minimum pressure drop, a temperature differential, or gravity. The liquid fluid may be driven by force using an implement, such as a pump. The surfaces of the upper plate 204 and lower plate 206 that form the convection cavity 240 that may be of a high surface area. As the upper plate 204 and lower plate 206 increase in temperature, liquid cooling fluid within the convection cavity 240 may circulate and remove heat through convection. The upper plate shoulder 252 and lower plate shoulder 254 may be used to direct liquid cooling fluid into the sinusoidal cooling apertures 212.

The features described in FIG. 2 may be mirrored when viewing the bipolar sinusoidal plate assembly 200 from the opposite side down the x axis.

The gasket supporting surfaces 203 may support a gasket, such as the cathode gasket 116 and anode gasket 122 in FIG. 1. The gasket enclosing surfaces may also close and seal the components of a hydrogen fuel cell 100. The gasket supporting surfaces 203 of the bipolar sinusoidal plate assembly 200 may be vertically aligned (e.g., the z axis may be normal to the exposed surfaces).

FIG. 3 shows a beaded gasket segment 300. A beaded gasket that may be used to space separate the interior components of the hydrogen fuel cell 100 from the upper plate 204 or lower plate 206 shown in FIG. 2. The beaded gasket segment 300 is a small portion of a beaded gasket. A beaded gasket may be substantially longer than the beaded gasket segment 300 shown in FIG. 3. The beaded gasket segment 300 and beaded gasket may also be referred to as a bead or a bead seal. The beaded gasket may also be part of a larger bead seal. A beaded gasket may be of a similar or slightly smaller circumference and shape to the outline of either the upper or lower plate.

FIG. 3 shows the beaded gasket segment 300 resembles a portion of a sinusoidal bridge from the bipolar sinusoidal plate assembly 200. FIG. 3 shows the beaded gasket is symmetrical and may be divided into two mirroring halves by a beaded gasket segment centerline plane 302. The centerline plane 302 may be vertical, wherein the centerline plane 302 may be parallel with a plane formed by the y and z-axes. An axis 303 may act as a longitudinal axis and/or a central axis for the beaded gasket segment 300. The beaded gasket segment 300 may be divided into a first portion 307 and a second portion 309 by a second plane 305. The axis 303 may be projected onto and extend with the centerline plane 302 and/or the second plane 305, for an example in a direction parallel with the y-axis.

The beaded gasket segment 300 may have a length 311. The length 311 is parallel with the axis 303. However, the entirety of the shape of the beaded gasket is formed from a sinusoidal bridge, such as the first structure 213a or the second structure 213b, that extends about the center of a plate. Other segments of the beaded gasket may have lengths parallel or axial to other axes. Additionally, other segments of the beaded gasket may have positions and lengths that change relative to an axis, due to the segment curving or changing direction. For example, a segment of a beaded gasket may curve and change direction with and when inserted into a sinusoidal arch that turns with a corner of a plate.

FIG. 3 shows a gasket cutout 304 in the beaded gasket segment 300. FIG. 3 shows the body of the gasket segment may form into a supportive wedge 306. FIG. 3 also shows the supportive wedge 306 may have a plurality of angled supporting walls 308 that mirror one another and are on opposite sides of the beaded gasket segment centerline plane 302. Alternatively, the supportive wedge 306 may have and be formed between supporting walls similar in function to the angled supporting walls 308 that may be vertical, such that the walls are normal to second plane 305. Alternatively, the supportive wedge 306 may have and be formed between supporting surfaces similar in function to the angled supporting walls 308 that may be curved instead of angled. Alternatively, the supportive wedge 306 may have and be formed supporting walls or surfaces similar in function to the angled supporting walls 308 that may asymmetric and non-mirrored about the centerline plane 302.

The first portion 307 may be located above the second plane 305. The second portion 309 may be located below the second plane 305. The axis 303 may be projected onto and extend along the second plane 305. Formed between first portion 307 and second portion 309 are a plurality of walls 308. There may be two walls 308, with each of the walls 308 on opposite sides of and mirrored over the centerline plane 302. FIG. 3 shows the underside and second portion 309 of the beaded gasket segment 300 may include a gasket sinusoidal arch 310 and a spandrel wedge 312. There may be a plurality of gasket sinusoidal arches 310 and spandrel wedges 312. The supportive wedge 306, gasket sinusoidal arches 310, and the spandrel wedges 312 may form a plurality of curves that are shaped to an openings of sinusoidal bridges 211, such as an opening in the first structure 213a or second structure 213b. A curve of the beaded gasket segment 300 shaped to the opening of a bridge may be referred to herein as a bridge-shaped curve. There may be a plurality of bridge-shaped curves repeating with the length 311 of the sinusoidal bridges 211, that may be referred to herein as repeating bridge-shaped curves. The bridge-shaped curves formed by the gasket sinusoidal arches 310 may repeat without any other curves besides curves formed on the spandrel wedges 312 therebetween.

FIG. 3 shows the top portion of the beaded gasket segment 300 may include a center ridge 314, a plurality of gasket troughs 316, and a plurality of bead flanks 318. The plurality of gasket troughs 316 may mirror one another and be on opposite sides of the beaded gasket segment centerline plane 302. The plurality of bead flanks 318 may mirror one another and be on opposite sides of the beaded gasket segment centerline plane 302. The gasket segment 300, and the gasket the gasket segment 300 may be formed from, may be of a width 319. The bead flanks 318 may extend from the gasket troughs 316 in the direction of the width 319. The width 319 may increase in distance when positioned closer to the top of the bead flanks 318 and decrease in distance closer to the bottoms of the spandrel wedges 312. For the example in view 301, the width 319 may be approximately parallel with the x-axis. Thickness 307a and thickness 309a may vary at different points along with the width 319 for the first portion 307 and second portion 309, respectively. For example, at a segment at the center of the width 319 the thickness 307a may be a greater distance than a point nearer to the edges of the width 319. For this example, the thickness 307a may vary in distance at different segments between the center and other positions of width 319 of the first portion 307. Likewise, at a segment at the center of the width 319 the thickness 309a may be a greater distance than a point nearer to the edges of the width 319.

There may be a first trough and a first bead flank, of the troughs 316 and the bead flanks 318, respectively, on a first side of the centerline plane 302. There may be a second trough and a second bead flank, of the troughs 316 and the bead flanks 318, respectively, on a second side of the centerline plane 302. The troughs 316 and bead flanks 318 may be approximately the same dimensions but mirrored with respect to the centerline plane 302.

FIG. 3 shows the gasket cutout 304. The beaded gasket segment 300 may be made of a singular material. However, other embodiments may exist where the gasket may be comprised of multiple layers of material or a composite of materials. The beaded gasket segment 300 and gasket may be made from an elastomer resistant to permeation of gases, such as polyolefin elastomer. For other examples, the elastomers in other embodiments may include other types of synthetic rubbers with a low porosity. Elastomers with low porosity may prevent hydrogen fuel 142 from diffusing out of the hydrogen fuel cell 100.

The beaded gasket segment 300 and beaded gasket may be created from an overmold of the upper plate 204 and/or lower plate 206 of the bipolar sinusoidal plate assembly shown in FIG. 2.

The second portion 309 of the beaded gasket segment 300 has a thickness 309a. The beaded gasket segment 300 and thickness 309a varies in a direction normal to the second plane 305. The beaded gasket segment 300 and thickness 309a varies at different points along the axis 303. For the example shown in view 301, the second portion 309 or lower portion of the beaded gasket segment 300 varies in thickness in the z direction or height when traveling along the length of the beaded gasket segment 300. The variation in thickness 309a is sinusoidal forming the plurality of bridge-shaped curves.

The thickness 309a may be at a minimum at a plurality of crowns 313. Each of the crowns 313 may be a peak of the gasket sinusoidal arches 310 and be located at the peak of a sinusoidal bridge, such as sinusoidal bridges 211. The thickness 309a may be at a maximum at the spandrel wedges 312. The spandrel wedges 312 may be inserted into a portion of a structure where plates may be closest to each other, such as near the contact points 218 of the upper and lower plates 204, 206 with reference to FIG. 2. The spandrel wedges 312 may be fit between arcs of sinusoidal variations in thickness of the gasket segment 300, such as the gasket sinusoidal arches 310. The spandrel wedges 312 may also be fit between sinusoidal variation in thickness of a bridge, such as between the upper sinusoidal arches 214 of the first structure 213a or the lower sinusoidal arches 216 of the second structure 213b with reference to FIG. 2.

Each of the gasket sinusoidal arches 310 may have a surface 326. The surfaces 326 curve with the sinusoidal shapes of the gasket sinusoidal arches 310 and the arches of a sinusoidal bridge, such as the upper sinusoidal arches 214 and lower sinusoidal arches 216 with reference to FIG. 2. The surfaces 326 that may abut and be in surface sharing contact with features formed by sinusoidal bridges 211, such as the first and second structures 213a, 213b with reference to FIG. 2. For example, the gasket sinusoidal arches 310 and surfaces 326 may be in surface sharing contact with feature such as the upper sinusoidal arches 214 of the first structure 213a or the lower sinusoidal arches 216 of the second structure 213b.

The length of the beaded gasket segment 300 in FIG. 3 is parallel with the y axis or a longitudinal axis. However, due to the continuous nature of a beaded gasket, the length of beaded gasket and other segments of the beaded gasket may have lengths along other axes or are variable lengths due to turning at a corner. The thickness of material in the z direction for lower portion of the beaded gasket segment 300 may be referred to as groove depth or cavity depth, due to the plate bead seal cavity the beaded gasket may be fit to and seal over. The lower portion of the beaded gasket segment 300 shown in FIG. 3 resembles the sinusoidal bridges 211 from the bipolar sinusoidal plate assembly 200 shown in FIG. 2. The gasket sinusoidal arch 310 may resemble an upper sinusoidal arch 214 and/or the lower sinusoidal arch 216 that may be offset and/or slightly enlarged. Additionally, the spandrel wedge 312 may resemble the portions of the upper sinusoidal arch 214 and/or the lower sinusoidal arch 216 that form into the sinusoidal bridge contact points 218. The spandrel wedges 312 may be fit to inner cavities formed by the first spandrels 232 and/or second spandrels 234. The beaded gasket segment 300 and beaded gasket may be created from an overmold of the upper plate 204 and/or lower plate 206 of the bipolar sinusoidal plate assembly shown in FIG. 2. The portions of the sinusoidal bridges 211 above and part of upper sinusoidal arch 214 and lower sinusoidal arch 216 that form the contact point in FIG. 3, may be somewhat hollow as spaced for the beaded gasket seal cavity (e.g., 402 in FIG. 4). FIG. 4 shows the arch crown (e.g. 410 in FIG. 4) and as spandrel trough (e.g., 412 in FIG. 4) part of the beaded gasket seal cavity (e.g., 402 in FIG. 4) that may be used to mold the beaded gasket segment 300 and beaded gasket.

The gasket sinusoidal arch 310 and spandrel wedge 312 may provide increased support and compressive strength to the beaded gasket segment 300. External forces are more evenly distributed across the gasket sinusoidal arch 310 and beaded gasket segment 300 compared to non-patent bead gaskets. More even distribution of external force may prevent the beaded gasket segment 300 from tearing and/or breaking the seal. External compressive force may be directed into the spandrel wedges 312. Increase in compressive strength of the beaded gasket segment 300 provided by the gasket sinusoidal arch 310 may allow for greater sealing pressure to be applied to the beaded gasket segment 300 to non-patent example beaded gaskets.

The top portion of the beaded gasket segment 300 and beaded gasket may be designed to interface with a flange or another form of fitting. The first portion 307 may act as the top portion of the beaded gasket segment 300. Specifically, the center ridge 314 may be inserted into the fitting of a flange or another form of fitting. For one example, center ridge 314 may be designed to couple into fitting in a gas diffusion membrane, such as a cathode diffusion membrane 118 or an anode diffusion membrane 124. For another example, center ridge 314 may also be designed to couple into fitting in the proton exchange membrane 110. The beaded gasket segment 300 and the beaded gasket may maintain a constant height in relation to the flange or another form of fitting. The width of the top portion of the beaded gasket segment 300 may vary in thickness in the z direction or height. The width of the top portion of the beaded gasket segment is along the x axis in FIG. 3. However, due to the continuous nature of a beaded gasket, the width of beaded gasket and other segments of the beaded gasket may have widths along other axes or are variable lengths due to turning at a corner. For one embodiment, in the center of the beaded gasket segment 300 is a center ridge 314.

The center ridge 314 has a bead roof 320 that directly interfaces and presses against the interior of a fitting, such as a flange on another plate. The beaded gasket segment 300 may be elastic allowing the bead roof 320 and center ridge 314 to conform to the shape of a fitting when inserted. An angled incline 322 diminishes the width of the center ridge 314 as the height in the z direction increases toward the bead roof 320. There may be a plurality of angled inclines 322, with at least two angled inclines 322 on opposite sides of the centerline plane 302. On a first side of the centerline plane 302 the angled incline 322 may extend at a first angle 324a from one of the troughs 316 toward the bead roof 320. On a second side of the centerline plane 302 the angled incline 322 may extend at a second angle 324b from one of the troughs 316 toward the bead roof 320. The first angle 324a and second angle 324b may be approximately the same dimensions and between 0 and 90 degrees. Likewise, the angled inclines 322 on opposite sides of the centerline plane 302 may have approximately the same dimensions, such as area or distance parallel with the direction of first angle 324a and second angle 324b, but mirrored with respect to the centerline plane 302.

FIG. 3 shows the base where the center ridge 314 meets the gasket troughs 316 may be substantially larger than the bead roof 320. The center ridge 314 has a width 330 approximately parallel with the width 319 and a height 332 approximately parallel with the centerline plane 302. The height 332 may increase in distance closer to the centerline plane 302. The height 332 may reach a maximum when coplanar with the centerline plane 302 at top of the bead roof 320. The width 330 may decrease in distance closer to the bead roof 320 and increase closer to the troughs 316, with respect to a vertical axis such as the z-axis. The width 330, height 332, and the angled incline 322 form a triangular shape for the ridge 314.

The first portion 307 has a thickness 307a that may be normal to the length 311 and width 330 of the gasket segment 300 and/or gasket. For one example, the thickness 307a may be vertical and parallel with the z-axis. Thickness 307a varies vertically, with respect to the z-axis, in a counter-axial direction, with respect to the axis 303. At the centerline plane 302 and the bead roof 320 the thickness 307a may of a distance that is a local maximum. The thickness 307a at the bead flanks 318 may be of a distance that is a local minimum. The thickness 307a at the troughs 316 may be at a local minimum. The thickness 307a at troughs 316 may be located below the bead flanks 318, with respect to the z-axis.

For one embodiment, the shape of the center ridge 314 may allow for the bead roof 320 be smaller than the opening of the interior a fitting, such as a flange. For this embodiment, the bead roof 320 and center ridge 314 may be inserted into the fitting with less resistance. For this embodiment and others, the angled inclines 322 may allow for less resistance as the center ridge 314 is inserted into a fitting. For this embodiment and others, the angled inclines 322 may reduce the chance the center ridge 314 may be removed from a fitting and break a seal.

FIG. 3 shows gasket troughs 316 depressed into the top of the beaded gasket segment 300. The gasket troughs 316 allow for the mouth of a gasket fitting to couple over the bead roof 320 and center ridge 314. The mouth of a fitting may clamp to the center ridge 314. The gasket troughs 316 may clamp around the mouth of gasket fitting. The elasticity of the beaded gasket segment 300 allows the gasket troughs 316 and portions of the bead flanks 318 to wrap around and couple the mouth of the fitting. When sealing pressure is applied the elastomer of gasket troughs 316 and portions of the bead flanks 318 may wrap around creating a seal on both sides of the mouth of the fitting.

FIG. 3 shows the bead flanks 318 may extend outward from the gasket troughs 316. The bead flanks 318 may be used to help create a seal against the fitting used around the center ridge. Additional the bead flanks 318 may extend the seal against surfaces of a gas exchange membrane, a proton exchange membrane 110, or other component of a hydrogen fuel cell 100 a fitting for the center ridge 314 may be attached to. The increased area of the seal created by the gasket segment 300 provided by the bead flanks 318 prevents gas, such as hydrogen fuel, from seeping into or out of the fitting and beyond the hydrogen fuel cell 100.

FIG. 3 shows the bead flanks 318 may be supported by the supportive wedge 306 and angled supporting walls 308. FIG. 3 shows an angled supporting wall of the supportive wedge 306 may be visible. Supportive wedge 306 and the angled supporting walls 308 may direct forces applied to the bead flanks 318, such as sealing pressure in the z direction, into the body of the beaded gasket segment 300 or a beaded gasket. This may reduce acute or chronic degradation to the beaded gasket segment 300.

FIG. 4 shows an overhead isometric view 401 of the beaded gasket segment 300 in a plate 400. For the embodiment shown in FIG. 4, the plate 400 may be the upper plate 204 of the bipolar sinusoidal plate assembly 200. Elements of the upper plate 204 described with respect to FIG. 2 included in FIG. 4 are equivalently numbered and may not be reintroduced, for brevity. For examples of other embodiments, the plate 400 may be the lower plate 206 of the bipolar sinusoidal plate assembly 200. For these examples, the second structure 213b, lower sinusoidal arches 216, and lower plate shoulder 254 may have features with similar dimensions, but mirrored with respect to the plane 202 with reference to FIG. 1, compared to features formed by first structure 213a, upper sinusoidal arches 214, and upper plate shoulder 252.

The section of plate 400 shown may be located between third side 407 and a fourth side 408. The section of plate 400 may be enclosed by a plurality of edges and may be bound by a plurality of edges, such as a first edge 440 closest to the left side 208, a second edge 442 closest to the right side 210, a third edge 444 closest to the third side 407, and a fourth edge 446 closest to the fourth side 408. The first edge 440, second edge 442, third edge 444, and fourth edge 446 act as arbitrary edges where details are omitted beyond for ease of illustration. Material and features of the upper plate 204 may extend past the first edge 440, second edge 442, and third edge 444.

FIG. 4 shows an overhead isometric view 401 of the upper plate 204 may include a beaded gasket seal cavity 402. The beaded gasket seal cavity 402 may be a cavity formed from an opening and inner surfaces of a structure forming sinusoidal bridges 211. The beaded gasket seal cavity 402 may act as a groove to support a gasket. The beaded gasket seal cavity 402 may be a bridge-shaped opening, wherein, features of seal cavity 402 may be formed to the shape of features sinusoidal bridges 211, such as upper sinusoidal arches 214. The lower plate 206 may have a seal cavity with dimensions approximately proportional and that mirror the seal cavity 402 with respect to the centerline plane 202. A substantial portion of beaded gasket seal cavity 402 extends longitudinally (e.g., down the length parallel with the y axis) the upper plate 204. The beaded gasket seal cavity 402 does have a curve that may be referred to as a beaded gasket cavity curve 404. As the beaded gasket seal cavity 402 approaches the right side of the upper plate 204, the beaded gasket cavity curve 404 gradually changes the direction of the beaded gasket seal cavity 402. The beaded gasket seal cavity 402 changes from being longitudinally aligned (e.g., the length of the beaded gasket seal cavity 402 is substantially parallel, within 5%, of the y axis) before the curve to being latitudinally aligned with the x axis (e.g. being substantially parallel the length of the beaded gasket seal cavity 402 is substantially parallel, within 5%, of the x axis). When longitudinally aligned, the length of a component may be parallel with a longitudinal axis. When latitudinally aligned, the length of a component may be anti-parallel and perpendicular to a longitudinal axis.

FIG. 4. shows the beaded gasket seal cavity 402 extends around a center of the upper plate 204 with the perimeter of the upper plate 204. The center of plate 400 and upper plate 204 may be a plate center 406. Plate center 406 may be located past the third side 407 and edge 440 of plate 400. FIG. 4 shows the beaded gasket seal cavity 402 may turn toward the plate center 406 of the upper plate 204. The beaded gasket seal cavity 402 may encircle the center of the upper plate. For other embodiments the beaded gasket seal cavity 402 or a cavity of approximately the same dimensions mirrored over centerline plane 202 may encircle the center of a lower plate 206. For some embodiments there may be a depression in a plate surrounded the beaded gasket seal cavity 402. The upper plate 204 extends past edge 440, where edge 440 is an arbitrary line where details are omitted beyond (to the upper left) the line for ease of illustration. The plate continues to the upper left of edge 440.

FIG. 4 shows the beaded gasket seal cavity 402 may be formed from components of sinusoidal bridges 211. FIG. 4 shows that much of the sinusoidal bridges are hollow space lacking material and a part of the beaded gasket seal cavity 402. The seal cavity 402 may act as the groove of the first structure 213a used to support gaskets. Likewise, a seal cavity of the lower plate 206 may act as the groove of the second structure 213b used to support gaskets, such as the gasket of gasket segment 300. The gasket segment 300 and/or the gasket formed from beaded gasket segment 300, may sealingly couple to the seal cavity 402. When sealingly coupled, gaseous exchange or leaks may be prevented between the surfaces of the seal cavity 402 and the surfaces of the gasket segment 300, or a gasket formed from gasket segment 300, in surface sharing contact with the seal cavity 402.

FIG. 4 shows the beaded gasket seal cavity 402 in the upper plate 204 contains a plurality of upper sinusoidal arches 214. In another embodiment, the beaded gasket seal cavity 402 in a lower plate 206 contains a plurality of lower sinusoidal arches 216. FIG. 4 shows upper sinusoidal arches 214 may have an arch crown 410 and a spandrel trough 412 visible when not covered by a beaded gasket segment 300 or a beaded gasket. In other embodiments with a lower plate 206, lower sinusoidal arches 216 may have an arch crown 410 and a spandrel trough 412 visible when not covered by a beaded gasket segment 300 or a beaded gasket. A plurality of arch haunches 414 connects and supports the arch crowns 410 to the spandrel troughs 412.

The beaded gasket segment 300 and the beaded gasket may sealingly couple to a single or a plurality of sinusoidal bridges 211. When a beaded gasket segment 300 is coupled to a structure of sinusoidal bridges 211, the center ridge 314, the gasket troughs 316, and the bead flanks 318 may be shown and visible from the perspective of FIG. 4. The height or thickness in the z direction of the center ridge 314, the gasket troughs 316, and the bead flanks 318 remain constant in the beaded gasket seal cavity 402. The top portion of the beaded gasket segment 300 including the center ridge 314, the gasket troughs 316, and bead flank 318, may remain at a constant height or z value with the length of the gasket segment 300. However, for other embodiments, the top portion of the beaded gasket segment 300, including the center ridge 314, the gasket troughs 316, and bead flank 318, may vary in height or z value with the length of the gasket segment 300. In FIGS. 3 and 4 the length of the beaded gasket segment 300 may be substantially longitudinal with the plate and parallel with the y-axis on the right side 210 of the beaded gasket cavity curve 404. The length of the beaded gasket may change in direction if and if not coupled to the beaded gasket seal cavity 402. For one example, in FIG. 4, the length of the beaded gasket may be longitudinal with the plate and parallel with the y axis to right side 210 of the beaded gasket cavity curve 404. For another example, in FIG. 4 the length of the beaded gasket may be parallel with the x axis on the left side 208 of the beaded gasket cavity curve 404. For another example, the direction of the length of the beaded gasket may be variable and changing in the beaded gasket cavity curve 404.

FIG. 4 shows the beaded gasket seal cavity 402 has an outer bridge incline 422 and an inner bridge incline 424. FIG. 4 show the outer bridge incline 422 of the upper plate 204 extends outward (e.g., away from the center of the upper plate 204) in the x direction and upward in the z direction. The outer bridge incline 422 may form into the upper plate shoulder 252 of the upper plate 204. Similarly, for another embodiment of another example, an outer bridge incline 422 may form into the lower plate shoulder 254 of the lower plate 206. FIG. 4 shows the inner bridge incline 424 of the upper plate 204 extends inward (e.g., toward the center of the upper plate 204) in the x direction and upward in the z direction. FIG. 4 shows for one embodiment of the upper plate 204, the inner bridge incline 424 may form into an incline plateau 426 between the beaded gasket seal cavity 402 and the plate center 406 on the upper plate 204. For another embodiment, the inner bridge incline 424 may form into an incline plateau 426 between the beaded gasket seal cavity 402 and the plate center 406 on a lower plate 206. FIG. 4 shows for one embodiment the outer bridge incline 422 and inner bridge incline 424 may be similar in shape. FIG. 4 shows for one embodiment the outer bridge incline 422 and inner bridge incline 424 may mirror one another within the beaded gasket seal cavity 402.

For the embodiment shown in FIG. 4, the bottom of the beaded gasket segment 300 may be coupled to the beaded gasket seal cavity 402. When a beaded gasket segment 300 is coupled to a structure of sinusoidal bridges 211, the angled supporting walls 308, the gasket sinusoidal arch 310 and the spandrel wedge 312 of the beaded gasket segment 300 may not be shown or visible from the perspective of FIG. 4. The surfaces of the spandrel the angled supporting walls 308, the gasket sinusoidal arch 310 and the spandrel wedge 312 may be in surface sharing contact and sealingly coupled to the surfaces of the beaded gasket seal cavity 402. For the embodiment shown in FIG. 4, the beaded gasket segment 300 may couple to the first structure 213a of the upper plate 204.

For the embodiment shown in FIG. 4 the beaded gasket segment 300 may sealingly couple to upper sinusoidal arches 214 of the upper plate 204. The spandrel wedge 312 of the beaded gasket segment 300 may be inserted into and sealingly couple to the spandrel trough 412. The gasket sinusoidal arch 310 of the beaded gasket segment 300 may enclose the arch crowns 410 and a substantial portion of the upper sinusoidal arch 214. The surfaces 326 may sealingly couple to the arch crowns 410 and arch haunches 414.

The FIG. 4 shows bead flanks 318 of the beaded gasket segment 300 and a beaded gasket may cover and be sealingly coupled to portions of the outer bridge incline 422 and inner bridge incline 424. Likewise, the angled supporting walls 308 of the beaded gasket segment 300 not visible in FIG. 4, may also be sealingly coupled to and cover the outer bridge incline 422 and inner bridge incline 424. For a lower plate 206 in other embodiments, portions of the bead flanks 318 and angled supporting walls 308 in the beaded gasket segment 300 may be sealingly coupled to and cover the outer bridge incline 422 and inner bridge incline 424.

The shape of and the thickness 309a in the z direction between the top of the gasket sinusoidal arch 310 and spandrel wedges 312, may reduce the formation of air pockets around in the spandrel trough 412 and near the arch crown 410. Likewise, the difference of thickness 307a and thickness 309a in the z direction and the x direction of the angled supporting walls 308 and bead flanks 318 in FIG. 3 may prevent air pocket formation against outer bridge incline 422 and the inner bridge incline 424. The varying height and structure of the underside of the beaded gasket segment 300 seal the arch crown 410, the spandrel trough 412, the outer bridge incline 422, inner bridge incline 424, and other surfaces of the beaded gasket seal cavity 402.

FIG. 4 shows the shape and structure of the beaded gasket seal cavity 402 may help support and distribute pressure from the beaded gasket segment 300 or beaded gasket in the upper plate 204. Similarly, for another embodiment, the shape and structure of the beaded gasket seal cavity 402 may help support and distribute pressure from the beaded gasket segment 300 or beaded gasket in the lower plate 206. The upper sinusoidal arches 214 and lower sinusoidal arches 216 may provide support to the beaded gasket segment 300 or a beaded gasket the beaded gasket segment 300 may be formed from. The sinusoidal shape of the arch crown 410 distributes pressure and other forces from the regions of the beaded gasket segment 300 or beaded gasket that may be thinner in the z direction into the arch haunches 414 and spandrel trough 412. For the upper plate 204, the shape of the outer bridge incline 422 and inner bridge incline 424 may distribute forces placed on the upper plate shoulder 252 and the bead flanks 318 into the sinusoidal bridges 211. For the lower plate 206, the shape of the outer bridge incline 422 and inner bridge incline 424 distribute forces placed on the lower plate shoulder 254 and the bead flanks 318 into the sinusoidal bridges 211.

The beaded gasket segment 300 and beaded gasket may be cast from an overmold with the sinusoidal bridges 211 and the beaded gasket seal cavity 402. For some embodiments, sinusoidal bridges 211 and the beaded gasket seal cavity 402 may have through-holes so the upper plate 204 and lower plate 206 may be overmolded in a single operation. For an example, a plurality of through-holes may be optionally located in and extend through the first and second surfaces 219a, 219b. The through-holes may be sealed from leaks or gaseous exchange via the spandrel wedges 312, walls 308, and bead flanks 318. For these embodiments, a bead gasket may be created for both an upper plate 204 and a lower plate 206 in a single operation. For some examples, the beaded gasket may be of an embodiment that may be removable from the beaded gasket seal cavity 402 of the upper plate 204 and/or lower plate 206. For other examples, the beaded gasket may be of an embodiment that may not be removable from the beaded gasket seal cavity 402 of the upper plate 204 and/or lower plate 206.

Thus, disclosed herein are systems and components for a bridge or a plurality of bridges that are sinusoidal in shape. The bridges may each support a beaded gasket for a bipolar plate. The bridges may each have a thickness that is normal to a plane formed between the two planes of a bipolar plane. The thickness is variable and may vary in distance normal to the lengths of and areas enclosed by the bridges, such as varying axially with respect to a z-axis. The thickness of each bridge may vary to form repeating sinusoidal pattern of regions without plate material, forming arches from the bridges that are sinusoidal in shape. The spandrels formed by the arches may serve as appendages at which a first plate and a second plate may join or couple to form the bipolar plate. The arches of the first plate and arches of a second plate may form a plurality of apertures. A fluid may enter through the apertures to cool and mitigate temperature between the first and second plate. The structures on a first plate and second plate that form bridges, may form a plurality of seal cavities of hollow volumes. A beaded gasket may be fit and sealingly coupled to the seal cavity and bridge, such that the inner surfaces of the seal cavity and bridge are sealingly couple to the beaded gasket. The beaded gasket may have a first portion and a second portion. The first portion may be a top portion and have a first thickness. The second portion may be a bottom portion and have a second thickness that are normal to lengths of the gasket and the area enclosed by the gasket, such as being axial relative to a z-axis. The first thickness of the first portion may not vary and remains constant along the lengths of the gasket. The first thickness may vary with respect to the width of the gasket. Alternatively, the first thickness may also vary along the lengths of the gasket. The first portion of the gasket may have a bead that may be inserted and pressingly coupled to a fitting, such as a flange. The second portion of the gasket has the second thickness that varies along the length of the gasket in a repeating sinusoidal pattern. The second portion of the gasket may sealingly couple and have surface sharing contact with the features enclosed by the grooves of a bridge. The grooves formed by a bridge may be referred to as seal cavities.

FIGS. 2-4 show example configurations drawn to scale with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

1. A system, comprising
a first plate arranged directly against a second plate and defining a gasket groove, the plates each parallel to one another and to a plane; and
a gasket formed in a plane and having a sinusoidal variation in a direction normal to the plane.

2. The system of claim 1 wherein the first plate is a first polar plate and the second plate is a second polar plate.

3. The system of claim 2 wherein the first polar plate and second polar plate are plates of a fuel cell.

4. The system of claim 3 wherein the plates form a plurality of bridge openings.

5. The system of claim 3 wherein the sinusoidal variation is along a centerline of the gasket.

6. The system of claim 5 wherein a bottom of the gasket includes the sinusoidal variation, and wherein a top of the gasket includes a bead having a center ridge between a first trough and a second trough in a direction of a width of the gasket.

7. The system of claim 6 wherein the center ridge extends in a direction along the centerline of the gasket.

8. The system of claim 7 wherein the bottom of the gasket further includes a spandrel wedge between arcs of the sinusoidal variation.

9. The system of claim 8 wherein the top further includes a first bead flank and a second bead flank respectively outside the first trough and the second trough in the direction of the width of the gasket.

10. The system of claim 9 wherein a thickness of the gasket varies along the centerline of the gasket, where it is thinner at bridge peaks of a plurality of bridges of the sinusoidal variation and is thicker at ends of the bridges where the first plate and the second plate come closest to each other.

11. A fuel cell system, comprising
a first polar plate arranged directly against a second polar plate forming a bipolar plate and defining a gasket groove, the plates each parallel to one another and to a plane; and
a gasket formed in a plane and having a repeating bridge-shaped curve in a direction normal to the plane.

12. The system of claim 11 wherein the plates form a plurality of openings, wherein the bridge-shaped curve repeats along a centerline of the gasket.

13. The system of claim 12 wherein a bottom of the gasket includes the bridge-shaped curve, and wherein a top of the gasket includes a bead having a center ridge between a first trough and a second trough in a direction of a width of the gasket.

14. The system of claim 13 wherein the center ridge extends in a direction along the centerline of the gasket.

15. The system of claim 14 wherein the bottom of the gasket further includes a spandrel wedge between arcs of the sinusoidal variation.

16. The system of claim 15 wherein the top further includes a first bead flank and a second bead flank respectively outside the first trough and the second trough in the direction of the width of the gasket.

17. The system of claim 16 wherein a thickness of the gasket varies along the centerline of the gasket, where it is thinner at bridge peaks of a plurality of bridges of the sinusoidal variation and is thicker at ends of the bridges where the first polar plate and the second polar plate come closest to each other.

18. The system of claim 17 wherein the first polar plate metal.

19. The system of claim 18 wherein the bridge-shaped curve is positioned in a bridge-shaped opening at each of the first polar plate and the second polar plate.

20. The system of claim 19 wherein the bridge-shaped curve repeats without any other curves therebetween other than the spandrel wedge.
